(19) United States
(12) Patent Application Publication
(10) Pub. No.: US 2018/0003987 A1
(43) Pub. Date: Jan. 4, 2018

(54) HEAD MOUNT DISPLAY

(71) Applicant: HITACHI-LG DATA STORAGE, INC., Tokyo (JP)

(72) Inventors: Ayano OTSUBO, Tokyo (JP); Takanori AONO, Tokyo (JP); Taketoshi MORIYAMA, Tokyo (JP); Kenji KIYA, Tokyo (JP); Manabu OCHI, Tokyo (JP)

(73) Assignee: HITACHI-LG DATA STORAGE, INC., Tokyo (JP)

(21) Appl. No.: 15/626,313

(22) Filed: Jun. 19, 2017

(30) Foreign Application Priority Data
Jul. 4, 2016 (JP) 2016-132155

(51) Int. Cl. G02B 27/01; G06F 1/20; G02B 7/00

(52) U.S. Cl. CPC G02B 27/0176; G02B 7/002; G06F 1/20; G02B 27/017; G02B 2027/0143; G02B 2027/0178; G02B 2027/0161

(57) ABSTRACT

A head mount display includes a display unit, a power source unit, a holding unit, and an adopter. The display unit displays a screen in a visibility direction of a user using the head mount display. The power source unit drives the display unit and includes a circuit board and a battery. The holding unit connects the display unit and the power source unit. The display is mounted on the head or a helmet of the user by the adopter. In the head mount display, the battery and the circuit board of the power source unit are disposed across a ventilation unit, and the ventilation unit is formed in an overhead direction of the user.

### CLAIM OF PRIORITY

The present application claims priority from Japanese patent application serial no. JP 2016-132155, filed on Jul. 4, 2016, the content of which is hereby incorporated by reference into this application.

### BACKGROUND OF THE INVENTION

### 1. Field of the Invention

The present invention relates to a head mount display.

### 2. Description of the Related Art

In recent years, a head mount display has been developed which is easily portable and can display a large screen in front of eyes of a user. The head mount display is an image display device like glasses and displays an image in front of eyes of a user via an optical system including a lens and a mirror by using a liquid crystal panel as a light source. The head mount display is mounted on the head of a user, and there are the both eyes type and the one eye type. In the both eyes type, a display unit is formed at a position corresponding to both eyes. In the one eye type, the display unit is formed at a position corresponding to a right or left eye. The head mount display enables a user to watch an image while moving his/her hands. Therefore, for example, an operator at a construction site is using the display during work.

An example of such the head mount display is described in JP 2013-54076 A. JP 2013-54076 A discloses that “An imaging device being mounted on the head of a user, being used with a head mount display, and being positioned in front of the forehead of the user, the imaging device comprising: an imaging unit configured to image a target object in a visibility direction of the user; a driving unit configured to drive the imaging unit; a heat dissipation member configured to dissipate heat generated from the driving unit; a circuit board mounting the imaging unit and the driving unit; and a housing configured to store the circuit board, wherein one end of the heat dissipation member is disposed in the housing, and another end of the heat dissipation member extends outside of the housing and extends in a direction away from the forehead of the user at the outside of the housing.”

### SUMMARY OF THE INVENTION

However, in the head mount display described in JP 2013-54076 A, a portion generating heat such as a light source unit is disposed at an upper portion of an attachment for glasses. Further, a circuit board and a battery are disposed in a closed space, and therefore cooling is insufficient, and an information amount is limited, and the display is driven only in a short time. To solve the issue, it is necessary to efficiently cool a circuit board and a battery.

In the future, a head mount display will be used in long time work in various environments, and information processed in a circuit board will increase. Therefore, heat generation amounts of a circuit board and a battery are increased. As a result, it is necessary to dispose the battery and the circuit board with an efficient heat dissipation structure. An object of the present invention is to provide a head mount display including a circuit board and a battery in one housing. The head mount display can process a large amount of information and be driven for a long time.

To solve the above-described issue, a head mount display includes a display unit, a power source unit, a holding unit, and an adopter. The display unit displays a screen in a visibility direction of a user using the head mount display. The power source unit drives the display unit and includes a circuit board and a battery. The holding unit connects the display unit and the power source unit. The adopter attaches the display on the head or a helmet of the user. In the head mount display, the battery and the circuit board of the power source unit are disposed across a ventilation unit, and the ventilation unit is formed in an overhead direction of the user.

According to the present invention, a head mount display can be provided which is capable of projecting an image with a large amount of information and long time driving. In addition, according to the present invention, a simple and high quality projection image can be maintained without including a cooling device in a head mount display.

A ventilation unit which dissipates heat in a circuit board of a power source unit is disposed on an inner side of a housing, and therefore the circuit board is efficiently cooled and safe.

An issue, a configuration, and an effect other than the above will be clarified by descriptions of the following embodiments.

### BRIEF DESCRIPTION OF THE DRAWINGS

FIG. 1 is a block diagram of a head mount display according to a first embodiment of the present invention;

FIG. 2 is an exploded perspective view of a power source unit of the head mount display according to the first embodiment of the present invention;

FIGS. 3A and 3B are sectional views of the power source unit of the head mount display according to the first embodiment of the present invention;

FIGS. 4A to 4C are schematic views illustrating a state using the head mount display according to the first embodiment of the present invention;

FIG. 5 is a block diagram of a head mount display according to a second embodiment of the present invention;

FIGS. 6A and 6B are views of a power source unit of the head mount display according to the second embodiment of the present invention;

FIGS. 7A to 7C are schematic views illustrating a state using the head mount display according to the second embodiment of the present invention;

FIG. 8 is a block diagram of a head mount display according to a third embodiment of the present invention;

FIGS. 9A and 9B are sectional views of a power source unit of the head mount display according to the third embodiment of the present invention;

FIG. 10 is a block diagram of a head mount display according to a fourth embodiment of the present invention; and

FIG. 11 is an exploded perspective view of a power source unit of the head mount display according to the fourth embodiment of the present invention.

### DESCRIPTION OF THE PREFERRED EMBODIMENTS

### First Embodiment

Embodiments of the present invention will be described below with reference to the drawings. Configurations denoted by the same reference signs include the same functions, and unless specifically mentioned, in the case where the functions have been already described, descriptions thereof will be omitted.

In addition, in necessary drawings, orthogonal coordinate axes including x axes, y axes, and z axes are described to clarify a description of a position of each unit.

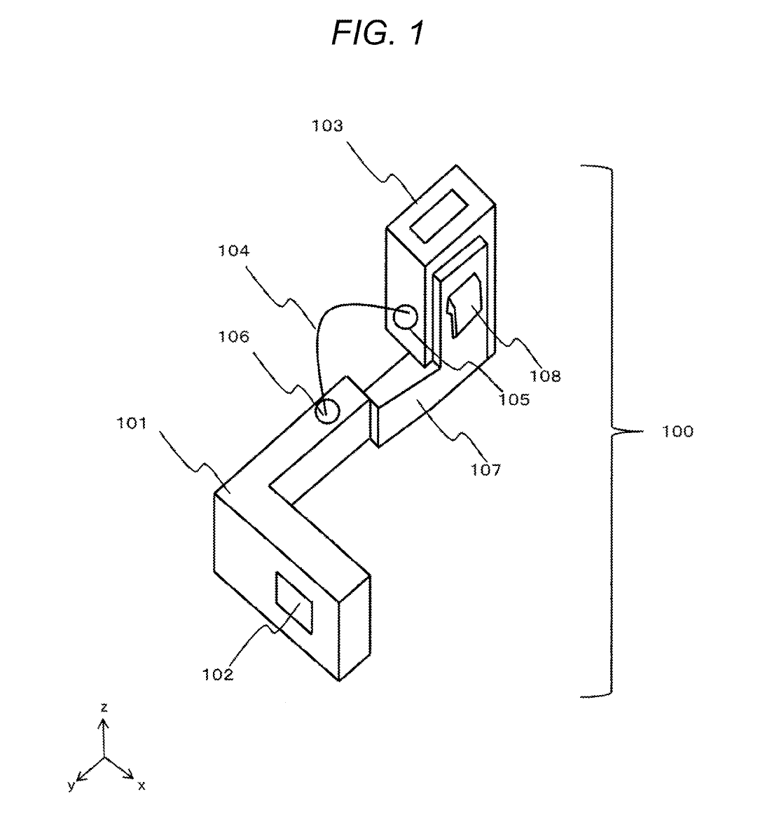

An example of a head mount display 100 according to the embodiment will be described. FIG. 1 is a block diagram of the head mount display according to the first embodiment of the present invention. In the embodiment, the one eye type display is indicated in which a display unit is positioned corresponding to the right eye. The both eyes type display includes two display units positioned corresponding to both eyes and has a configuration similar to the one eye type. As illustrated in FIG. 1, the head mount display 100 includes a display unit 101, a screen 102, a power source unit 103, a wiring 104, connectors 105 and 106 of the wiring 104, a holding unit 107, and an adopter 108. The display unit 101 includes a light source. The screen 102 displays an image in front of eyes of a user. The power source unit 103 includes a driving circuit board and a battery of the display unit. The wiring 104 connects the display unit 101 and the power source unit 103. The holding unit 107 supports the display unit and the power source unit. The adopter 108 connects the head mount display and a helmet. The display unit 101 and the power source unit 103 are disposed as illustrated in the drawing.

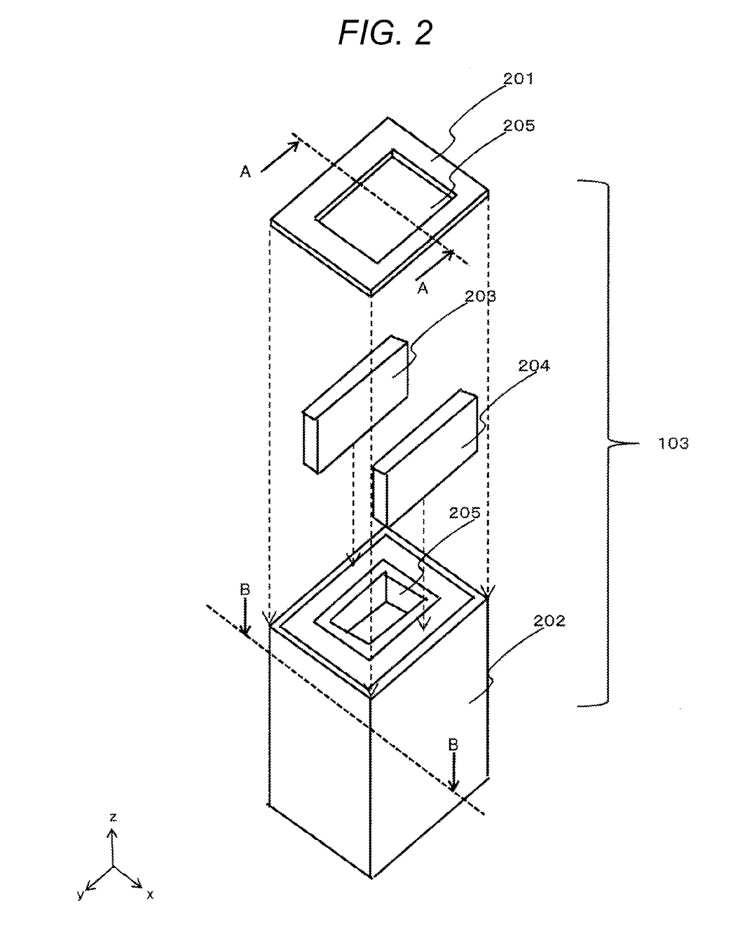

FIG. 2 is an exploded perspective view of the power source unit 103 of the head mount display according to the first embodiment of the present invention.

A housing of the power source unit 103 includes a housing 201 on an upper side of the power source unit, and a housing 202 on a lower side of the power source unit. The housing 201 on the upper side of the power source unit and the housing 202 on the lower side of the power source unit include a ventilation unit 205. In the housing, a battery 203 and a circuit board 204 are disposed. Large surface areas of the battery 203 and the circuit board 204 are disposed opposed to each other. The ventilation unit 205 is positioned between the battery 203 and the circuit board 204. The housing 201 on an upper side of the power source unit and the housing 202 on a lower side of the power source unit are formed of metal such as magnesium die-casting and aluminum or resin. In FIG. 2, the circuit board 204 and the battery 203 are covered by the housing 202 on a lower side of the power source unit. However, the ventilation unit 205 may be simply formed on a bottom surface of the housing 202 on a lower side of the power source unit. As illustrated in FIG. 2, when a recessed portion is formed on the housing 202 on a lower side of the power source unit, the battery 203 and the circuit board 204 can be protected from dust and water in the outside environment.

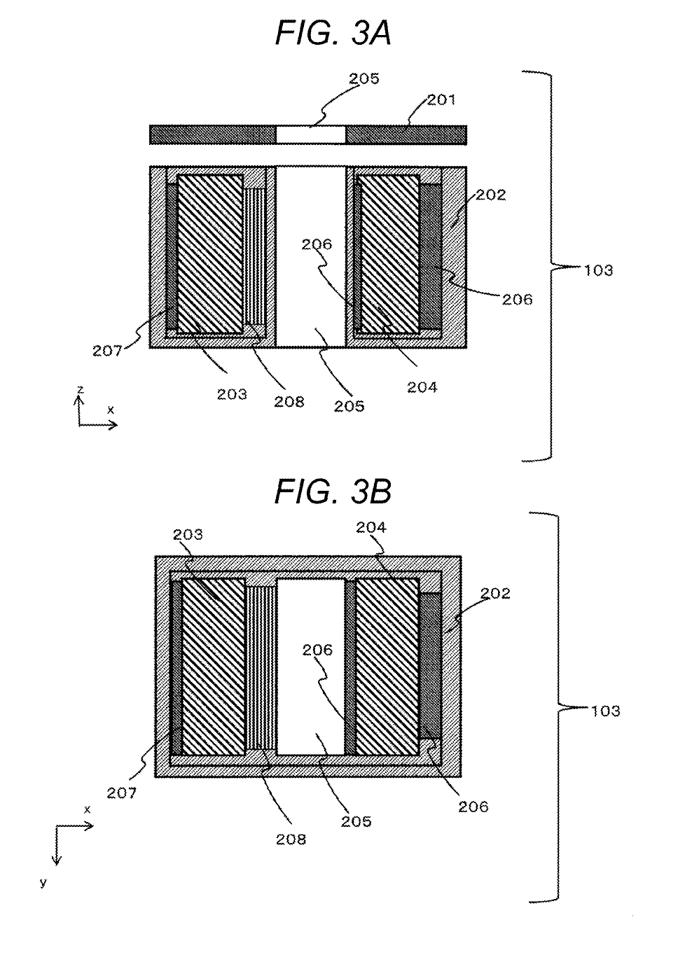

FIG. 3A is a sectional view on line AA illustrated in FIG. 2 of the power source unit 103 of the head mount display according to the first embodiment of the present invention.

FIG. 3B is a sectional view (upper surface view) on line BB illustrated in FIG. 2 in a state in which the housing 201 on an upper side of the power source unit 103 of the head mount display according to the first embodiment of the present invention is removed. The battery 203 and the circuit board 204 are disposed in the housing 202 on a lower side of the power source unit. Heat generation amounts of the battery 203 and the circuit board 204 are large. Therefore the battery 203 and the circuit board 204 are mounted in the housing 202 on a lower side of the power source unit via heat dissipation sheets 206 and 207 to facilitate heat dissipation in the housing. The heat dissipation sheets are not needed when temperatures in the battery and the circuit board are equal to or less than a heat resistance temperature of each of them while being driven even if the heat dissipation sheets are not disposed. Further, the battery 203, the circuit board 204, and the housing 202 on a lower side of the power source unit may be fixed by such as screws.

Furthermore, a heat insulation sheet 208 may be disposed instead of a heat dissipation sheet between the battery 203 and the circuit board 204. Since heat generation amounts of the battery 203 and the circuit board 204 are different, the heat insulation sheet 208 can prevent that heat generated by each of the battery 203 and the circuit board 204 moves to a side where the heat generation amount is lower. Since air is included in the battery 203 and the circuit board 204 by the ventilation unit 205 disposed between the battery 203 and the circuit board 204, it is prevented that heat generated by each of the battery 203 and the circuit board 204 moves to a side where the heat generation amount is lower. When either of the battery 203 or the circuit board 204 in which generates more power is connected on the ventilation unit 205 side via a heat dissipation sheet, a heat dissipation area is increased since the ventilation unit 205 is disposed, and a heat dissipation effect is increased. In addition, the housing 202 on a lower side of the power source unit may be divided into two so as to be easily assembled.

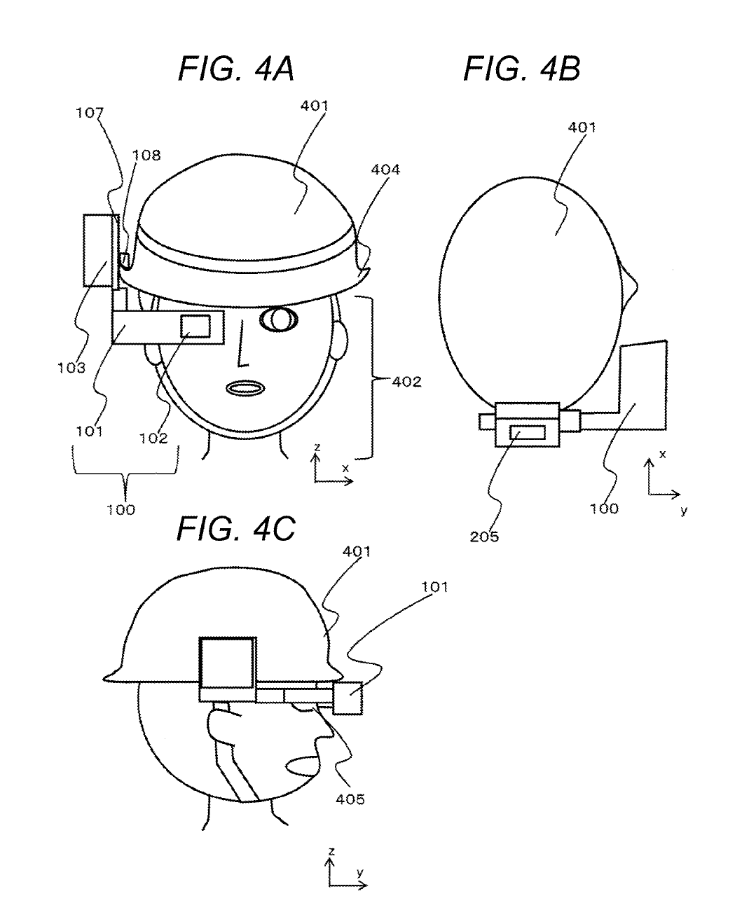

FIGS. 4A to 4C are views illustrating a state using the head mount display according to the first embodiment of the present invention.

FIG. 4A is an elevation view. FIG. 4B is an upper surface view. FIG. 4C is a side surface view.

An operator 402 wears a helmet 401 on his/her head during work. The helmet 401 and the head mount display 100 are attached to an outer peripheral portion 404 of the helmet via the adopter 108 to connect to the helmet or the head.

The display unit 101 is provided in front of eyes 405 of the operator 402 using the head mount display. A flat surface of the screen 102 of the display unit 101 and the power source unit 103 are disposed on a vertical flat surface. When the ventilation unit 205 in a space between a battery and a circuit board of the power source unit is disposed vertical to the display unit 101, the power source unit 103 generates a large amount of heat can effectively dissipate heat by natural convection. Further, when the power source unit is positioned in an overhead direction or upper than ears of the operator 402 when the display unit is set to an x-axis direction, a helmet is positioned between the operator 402 and the circuit board and the battery which generate heat, and therefore the operator is safe since a distance is formed by the helmet.

Furthermore, by disposing, on the ventilation unit 205 side, a portion where heat is most generated, it is prevented that an operator is in contact with the portion, and therefore the operator is safe.

One of the head mount displays according to the present invention is mounted on the head of a user. The head mount display includes a display unit, a power source unit, a holding unit, and an adopter. The display unit displays a screen in a visibility direction of the user using the head mount display. The power source unit drives the display unit and includes a circuit board and a battery. The holding unit connects the display unit and the power source unit. The display is mounted on the head or a helmet by the adopter. In the head mount display, the battery and the circuit board of the power source unit are displayed across a ventilation unit, and the ventilation unit is formed in an overhead direction of the user.

According to the present invention, a head mount display can be provided in which an image performance is constant for a long time. In addition, in the present invention, a safe, simple and high quality projection image can be maintained without providing a cooling device to the head mount display.

### Second Embodiment

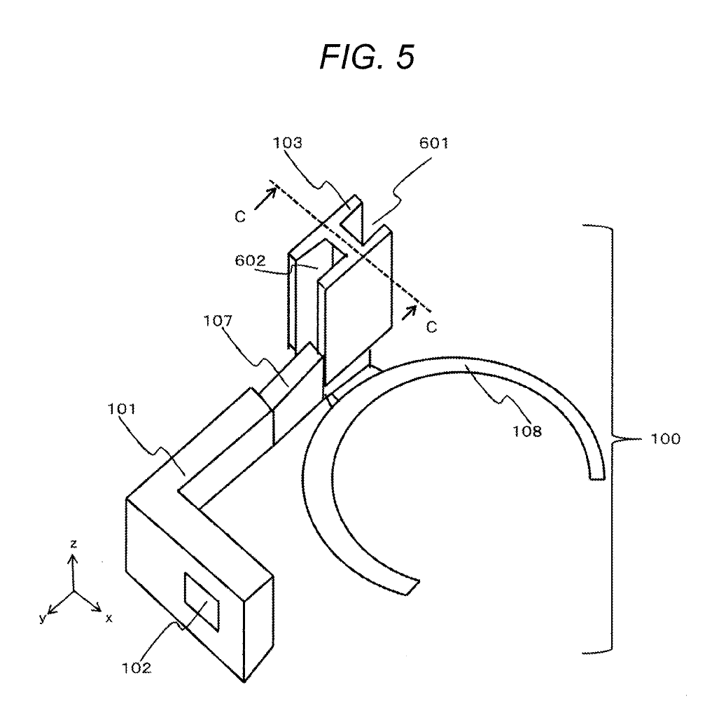

FIG. 5 is a block diagram of a head mount display according to a second embodiment of the present invention.

In the second embodiment, structures of the power source unit 103 and an adopter 108 are different from the structures in the first embodiment. The adopter 108 has a U-shape so as to be directly mounted on the head of an operator.

The power source unit 103 has an H-shape, and two spaces 601 and 602 are formed between a battery and a circuit board.

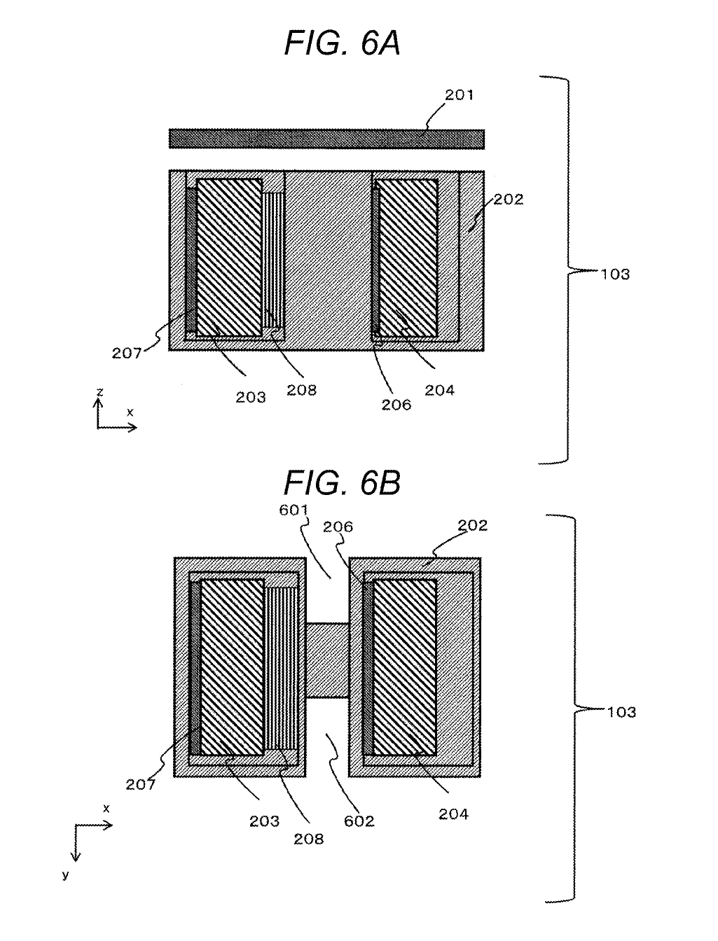

FIGS. 6A and 6B are sectional views of the power source unit 103 of the head mount display according to the second embodiment of the present invention. FIG. 6A is a sectional view on line CC illustrated in FIG. 5. FIG. 6B is an upper surface view in a state in which a housing 201 on an upper side of the power source unit 103 is removed.

Heat is dissipated since the spaces 601 and 602 are formed between a battery 203 and a circuit board 204. Therefore, heat transfer can be suppressed between the battery 203 and the circuit board 204.

When a surface, on which a heat generation amount is large, of the circuit board 204 is in contact with the spaces 601 and 602 side via a heat dissipation sheet, a heat dissipation efficiency of a ventilation unit is increased. Further, the heat dissipation efficiency is increased when the battery 203 is in contact with a housing opposed to the spaces 601 and 602 via a heat dissipation sheet. In addition, by providing a heat insulation sheet on the spaces 601 and 602 side of the battery 203, heat transfer from the circuit board 204 can be suppressed, and long-time drive can be possible.

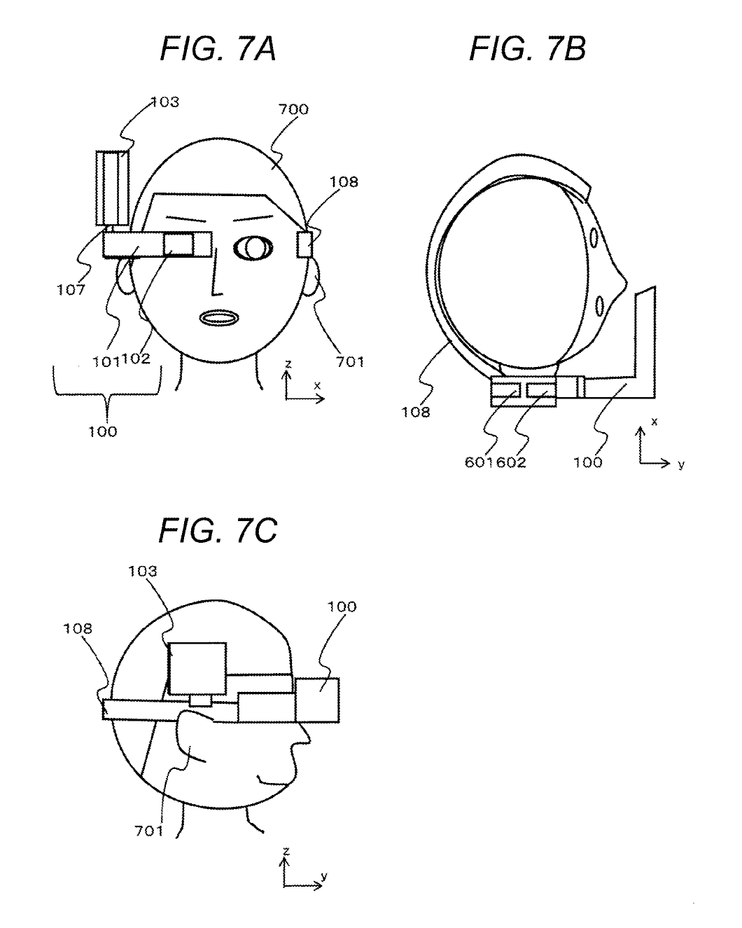

FIGS. 7A to 7C are views illustrating a state using the head mount display according to the second embodiment of the present invention.

FIG. 7A is an elevation view. FIG. 7B is an upper surface view. FIG. 7C is a side surface view.

An operator 700 wears the adopter 108 on the head. The adopter 108 is wound around so as to put on ears 701 of the operator 700. The adopter 108 may be made of resin, rubber, or metal such as aluminum. If the adopter 108 is formed of metal, a heat dissipation area is further increased, and heat is further dissipated. Further, the adopter 108 may be formed by combining resin and metal.

As described above, according to the second embodiment, in comparison with the first embodiment, a heat dissipation area of the power source unit 103 is increased, and also effects by natural convection can be obtained.

### Third Embodiment

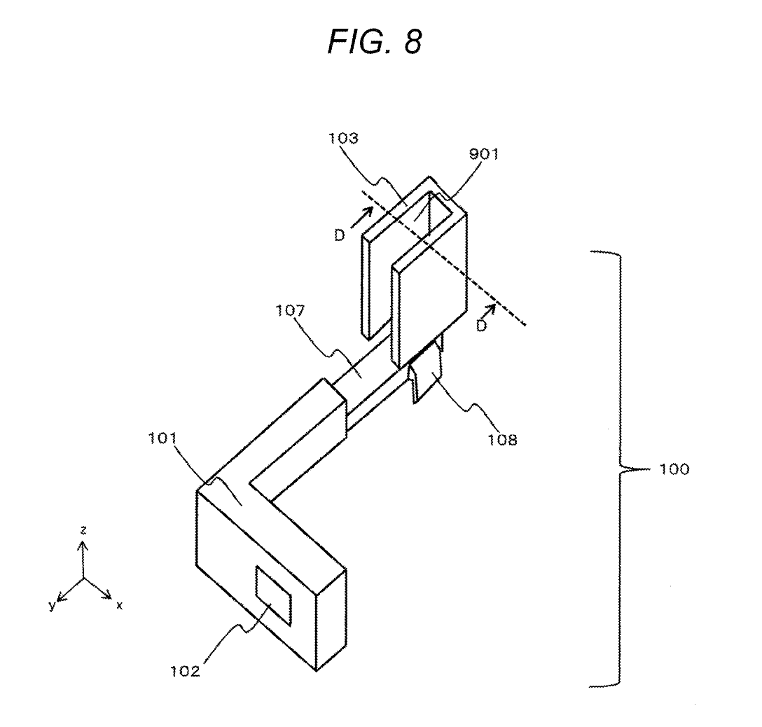

FIG. 8 is a block diagram of a head mount display according to a third embodiment of the present invention.

In the third embodiment, a structure of the power source unit 103 is different from the structure in the first embodiment. The power source unit 103 has a substantially U-shape, and a space 901 is formed between a battery and a circuit board.

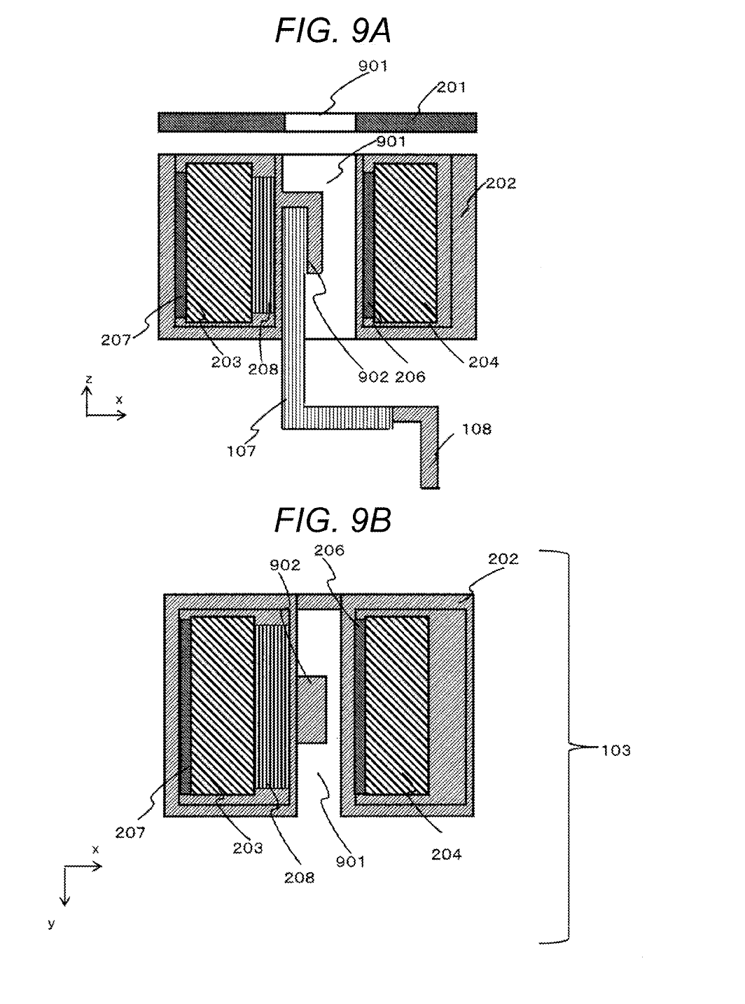

FIGS. 9A and 9B are sectional views of the power source unit 103 of the head mount display according to the third embodiment of the present invention. FIG. 9A is a sectional view on line DD illustrated in FIG. 8. FIG. 9B is an upper surface view in a state in which a housing 201 on an upper side of the power source unit 103 is removed.

Heat is dissipated since the space 901 is formed between a battery 203 and a circuit board 204. Therefore, heat transfer can be suppressed between the battery 203 and the circuit board 204. When a surface, on which a heat generation amount is large, of the circuit board 204 is in contact with the space 901 side via a heat dissipation sheet, a heat dissipation efficiency in the space is increased. Further, the heat dissipation efficiency is increased when the battery 203 is in contact with a housing opposed to the space 901 via a heat dissipation sheet. In addition, by providing a heat insulation sheet 208 on the space 901 of the battery 203, heat transfer from the circuit board 204 can be suppressed, and long-time drive can be possible.

As described above, according to the third embodiment, in comparison with the first embodiment, a heat dissipation area of the power source unit 103 is increased, and also effects by natural convection can be obtained.

### Fourth Embodiment

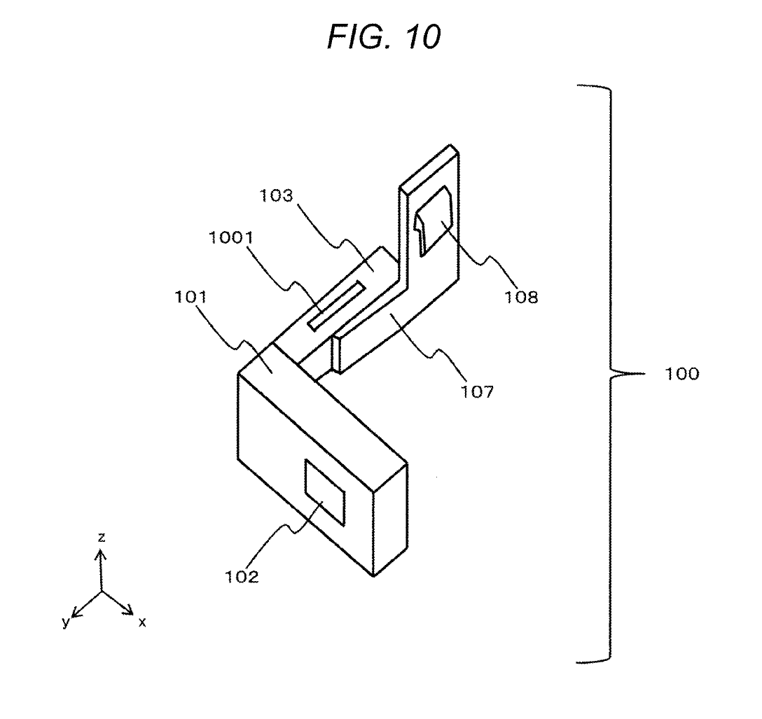

FIG. 10 is a block diagram of a head mount display according to a fourth embodiment of the present invention.

The fourth embodiment is different from the first embodiment in the aspect that a display unit 101 and a power source unit 103 are integrated. A space 1001 is formed in the power source unit 103.

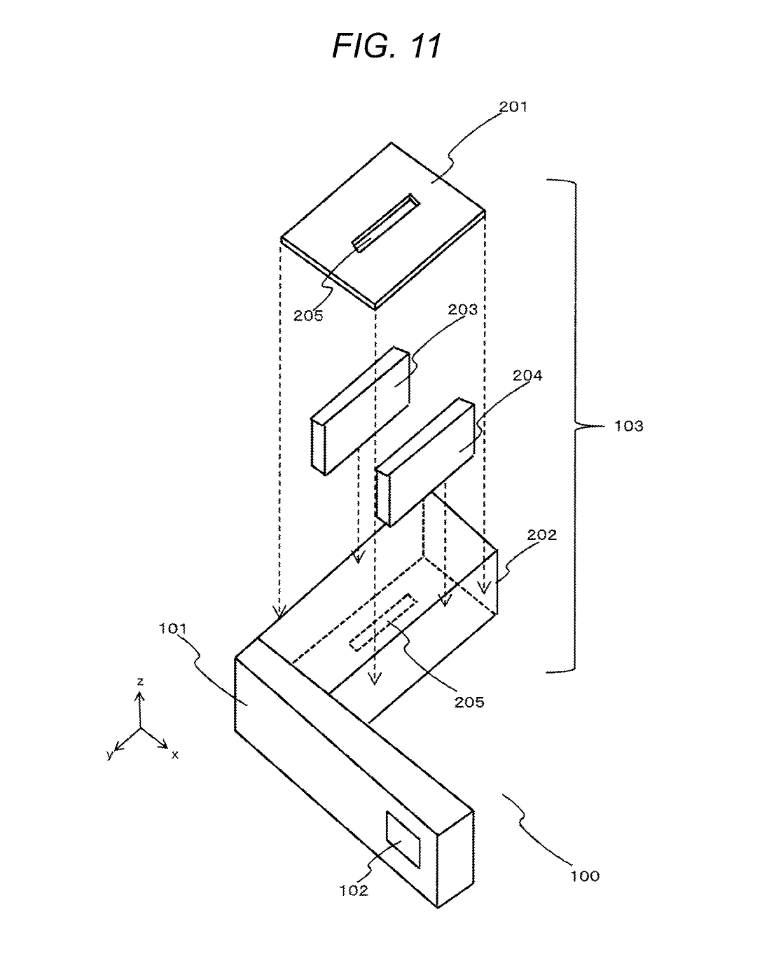

FIG. 11 is an exploded perspective view of the power source unit 103 of the head mount display according to the fourth embodiment of the present invention.

A housing of the power source unit 103 includes a housing 201 on an upper side of the power source unit, and a housing 202 on a lower side of the power source unit. The housing 201 on the upper side of the power source unit and the housing 202 on the lower side of the power source unit include the space 1001 which can ventilate in a z direction. The battery 203 and the circuit board 204 are disposed opposed to the space 1001. Heat can be dissipated from both surfaces of the battery 203 and the circuit board 204 according to the above-described structure, and an image with a large amount of information can be projected for a long time.

As described above, in the present invention, in comparison with the first embodiment, the power source unit 103 is integrated with the display unit 101. Therefore, the head mount display is small-sized, and an operator can easily use the display.

According to the embodiments of the present invention, a head mount display can be provided in which an image performance is constant for a long time. Further, in the present invention, a simple and high quality projection image can be maintained without including a cooling device in the head mount display.

Further, the above-described embodiments describe the present invention in detail for clarification, and every configurations described above may not be necessarily included. Further, a configuration of each embodiment can be partially replaced to configurations of the other embodiments. Furthermore, a part of or all of configurations of the other embodiments can be added to a configuration of each embodiment.

What is claimed is:

1. A head mount display, comprising:
a display unit configured to display a screen in a visibility direction of a user;
a power source unit configured to drive the display unit and including a circuit board and a battery;
a holding unit configured to connect the display unit and the power source unit; and
an adopter configured to attach the display on the head or a helmet of the user,
wherein the battery and the circuit board of the power source unit are disposed across a ventilation unit, and the ventilation unit is formed in an overhead direction of the user.

2. The head mount display according to claim 1, wherein the circuit board of the power source unit is disposed on a helmet side or an upper direction from ears of the user.

3. The head mount display according to claim 1, wherein a heat dissipation sheet is disposed between the circuit board of the power source unit and the ventilation unit.

4. The head mount display according to claim 1, wherein a heat insulation sheet is disposed between the battery of the power source unit and the ventilation unit.

5. The head mount display according to claim 1, wherein the holding unit holding the adopter is disposed in the ventilation unit.
